(19) United States
(12) Patent Application Publication
(10) Pub. No.: US 2024/0202402 A1
(43) Pub. Date: Jun. 20, 2024

(54) METHOD AND SYSTEM FOR AUTOMATED DESIGN GENERATION WITH INERTIAL CONSTRAINTS

(71) Applicant: Palo Alto Research Center Incorporated, Palo Alto, CA (US)

(72) Inventors: Clinton Morris, San Carlos, CA (US); Amirmassoud Mirzendehdel, Millbrae, CA (US); Morad Behandish, Mountain View, CA (US)

(73) Assignee: Palo Alto Research Center Incorporated, Palo Alto, CA (US)

(21) Appl. No.: 18/082,665

(22) Filed: Dec. 16, 2022

(51) Int. Cl. G06F 30/23

(52) U.S. Cl. CPC G06F 30/23; G06F 2119/18

(57) ABSTRACT

A modification of a topology optimization formulation for part-level generation is provided such that it includes additional constraints that ensure that the inertial quantities (e.g., COM, Mol, and mass) of an automatically generated part are equivalent to specified targets. These targets are the inertial values used in an initial assembly-level simulation. The reaction and external forces acting on the part of interest resulting from assembly-level simulation provide the boundary conditions used for part-level generation. By constraining the inertial properties in this way, there is no need to evaluate the assembly-level dynamics each time a part is generated.

### BACKGROUND

Automated design generation is a well-known but evolving field. For example, there is previous work on consideration of inertial constraints in automated design generation. Examples include: [Bendsøe, Martin P., and Ole Sigmund. “Material interpolation schemes in topology optimization.” Archive of applied mechanics 69, no. 9 (1999): 635-654], [Kang, Zhan, Chi Zhang, and Gengdong Cheng. “Structural topology optimization considering mass moment of inertia.” Proc. of the 6th world congresses of structural and multidisciplinary optimization, Rio de Janeiro, Paper 4611 (2005)], and [Zhou, Pingzhang, Guotao Ou, and Jianbin Du. “Topology optimization of continua considering mass and inertia characteristics.” Structural and Multidisciplinary Optimization 60, no. 2 (2019): 429-442].

### BRIEF DESCRIPTION

In one aspect of the presently described embodiments, a method for automated design generation comprises receiving design domain and boundary conditions for at least one part of an assembly to be generated; evaluating an objective and constraints; computing decision variables based on the objective and the constraints; augmenting or filtering the decision variables based on at least a plurality of inertial considerations; determining or updating design variables based on decision variables; generating a design for the at least one part; and outputting information configured to realize or manufacture the at least one part.

In another aspect of the presently described embodiments, the evaluating comprises performing a finite element analysis.

In another aspect of the presently described embodiments, the decision variables comprise gradients and sensitivity fields.

In another aspect of the presently described embodiments, the plurality of inertial considerations comprises mass, moment of inertia, and center of mass.

In another aspect of the presently described embodiments, the augmenting or filtering is also based on design or manufacturing considerations.

In another aspect of the presently described embodiments, the outputting information configured to realize or manufacture comprises outputting information configured for at least one of: three-dimensional printing, additive manufacturing, subtractive manufacturing, or hybrid manufacturing.

In another aspect of the presently described embodiments, the method further comprises outputting information for further simulation or analysis before realization or manufacturing.

In one aspect of the presently described embodiments, a system for automated design generation, the system comprising: at least one processor and at least one memory having instructions stored thereon wherein execution of the instructions by the processor causes the system to: receive design domain and boundary conditions for at least one part of an assembly to be generated; evaluate an objective and constraints; compute decision variables based on the objective and the constraints; augment or filter the decision variables based on at least a plurality of inertial considerations; determine or update design variables based on decision variables; generate a design for the at least one part; and output information configured to realize or manufacture the at least one part.

In another aspect of the presently described embodiments, the evaluating comprises performing a finite element analysis.

In another aspect of the presently described embodiments, the decision variables comprise gradients and sensitivity fields.

In another aspect of the presently described embodiments, the plurality of inertial considerations comprises mass, moment of inertia, and center of mass.

In another aspect of the presently described embodiments, the augmenting or filtering is also based on design or manufacturing considerations.

In another aspect of the presently described embodiments, the information output to realize or manufacture comprises at least one of information configured for: three-dimensional printing, additive manufacturing, subtractive manufacturing, or hybrid manufacturing.

In another aspect of the presently described embodiments, the system further comprises a realization or manufacturing system.

In another aspect of the presently described embodiments, the realization or manufacturing system comprises at least one of: a three-dimensional printing system, an additive manufacturing system, a subtractive manufacturing system, or a hybrid manufacturing system.

In another aspect of the presently described embodiments, the system is further caused to perform further analysis or simulation before information is output to realize or manufacture the part.

### BRIEF DESCRIPTION OF THE DRAWINGS

FIG. 1 is a workflow according to the presently described embodiments;

FIG. 2(a) shows an example design using volume fraction (or mass) as an inertial constraint;

FIG. 2(b) shows an example design using moment of inertia (Mol) as an inertial constraint;

FIG. 2(c) shows an example design using volume fraction (or mass) and moment of inertia (Mol) as inertial constraints;

FIG. 2(d) shows an example design using volume fraction (or mass), moment of inertia (Mol) and center of mass (COM) as inertial constraints;

FIG. 3 is a flowchart illustrating a method according to the presently described embodiments; and.

FIG. 4 is an example system according to the presently described embodiments.

### DETAILED DESCRIPTION

Although, as noted above, there are known approaches to automated design, there still exists difficulties when the process involves the coupling of assembly-level design with automated part-level design generation. Typically, integrating part-level design with assembly-level design requires iterations across scales, e.g., iterations between part level analysis and assembly level analysis, to ensure the part-level changes to inertial properties do not adversely impact the dynamic behavior of the whole assembly. Additionally, the reaction forces and external forces applied to a component must be updated to accommodate the change in dynamics resulting from the inertia changes.

Thus, according to the presently described embodiments, a standard topology optimization formulation, e.g., in(\ref{eq_TOproblem}), is modified such that it includes additional constraints that ensure the inertial quantities, such as center of mass (COM), moment of inertia (Mol), and volume fraction (or mass), of the automatically generated part are equivalent to specified targets. These targets are the inertial values used in the initial assembly level simulation. The reaction and external forces acting on the component of interest resulting from assembly-level simulation provide the boundary conditions used for part-level generation. Constraining the inertial properties according to the presently described embodiments eliminates or reduces the need to evaluate the assembly-level dynamics each time a part is generated.

That is, according to the presently described embodiments, an innovative method and system is provided for coupling assembly-level design with automated part-level design generation by effectively using inertial constraints. Implementation of the presently described embodiments facilitates an effective systematic approach to automate design generation. This approach ensures that inertial properties (e.g, total mass, center of mass, and inertial tensor) are simultaneously (or substantially simultaneously or concurrently) and exactly (or substantially or within an acceptable range) met in the design of a part, e.g., a replacement part, without imposing unnecessary artificial constraints on the geometric complexity of the part. The approach enables efficient and effective design space exploration by finding nontrivial complex designs which satisfy performance objectives while ensuring that part-level inertial properties sufficiently, e.g., exactly, match specified targets.

To further explain, additive manufacturing (AM) technologies are capable of fabricating geometrically complex parts by adding material layer-by-layer. The growing interest in AM, specifically metal-AM, stems from its ability to leverage geometric complexity to design high-performance light-weight designs for applications in aerospace, automotive, medical, etc.

Kinematic and dynamic solvers can predict the motions and forces experienced by multibody systems. For determinant systems, the motion and forces can be sufficiently, e.g., exactly, determined with only the kinematic relationships between the bodies and the inertial properties (e.g., mass, location of the center of mass, and moments of inertia) of each component. For example, when solving a linear system of equations in such a context, a unique and well-defined solution will result. Regardless of the shape of the individual parts, as long as the inertial values and kinematic relationships are unchanged, the assembly will experience the same forces and motion. For assemblies such as robotic arms, steering assemblies, and cutting tools, dynamic (as opposed to static) forces dominate the experience of a part.

With the advances in computational hardware, material sciences, and manufacturing technologies, there is a great potential to navigate the expanded design space and introduce novel low-cost high-performance designs that can have multiple functions. Over the past few years, different automated design techniques such as topology optimization, machine learning, cellular automata, etc., have been developed. These techniques, to varying degrees, consider the physical performance of a part to generate non-trivial organic shapes.

In general, automated part design can be broken down into the following:
(1) Domain Specification: providing the design domain and boundary conditions for the part to be generated;
(2) Physics-based Performance Analysis: invoking physics solvers such as finite element analysis to evaluate the objective and constraints;
(3) Computing Decision Variables: computing the optimization decision variables such as gradients, sensitivity fields, etc. based on the objective and constraints;
(4) Design and Manufacturing Constraints: augment/filter decision variables based or design and manufacturing considerations; and,
(5) Design Generation: update design variables based on decision variables and generate an optimized design.
   Mathematically, automated design generation is typically implemented by solving the following optimization problem:

$$\begin{matrix}Minimize & φ ( Ω ) , \\ Ω ⊆ {Ω}_{0} & \end{matrix} \qquad ( 1 a ) ( objective function )$$

$$\begin{matrix}such that & [ {K}_{Ω} ] [ {u}_{Ω} ] = [ f ] ,\end{matrix} \qquad ( 1 b ) ( state equation )$$

$${V}_{Ω} \leq {V}_{target} , \qquad ( 1 c ) ( constraint )$$

where φ(Ω)∈R is the value of objective function for a given design Ω⊆Ω₀. [f], [u_{Ω}], and [K_{Ω}] are (discretized) external force vector, displacement vector, and stiffness matrix, respectively, for finite element analysis (FEA). V_{Ω}: =vol[Ω] represents the design volume and V_{target}>0 is the volume budget. Note, in this formulation, the mass (volume fraction) is the only constrained inertial property.

When using the above formulation, as previously noted, integrating part-level design with assembly-level design requires iterations across scales to ensure the part-level changes to inertial properties do not adversely impact the dynamic behavior of the whole assembly. Also, part-level geometric changes impact part-level loading conditions due to coupling of dynamic behavior at the assembly level.

Additionally, the reaction forces and external forces applied to a component must be updated to accommodate the change in dynamics resulting from the inertia changes. In this regard, existing/legacy parts have predictable vibration performance which strongly depends on inertial characteristics. Changing these values arbitrarily during design generation can have unexpected consequences to system performance not modeled by the dynamic solver.

Further, efficient design space exploration relies on casting of constraints as locally differentiable functions.

As discussed above, there is previous work wherein single inertial constraints are used in automated design generation; however, there is no known robust formulation that can precisely and simultaneously prescribe the precise value of a plurality of relevant inertial properties (e.g., all relevant inertial properties) such that the performance of a dynamic assembly is unchanged.

Therefore, according to the presently described embodiments, the standard topology optimization formulation in the Equations (1a, 1b, 1c) above is modified such that it includes additional constraints that ensure the inertial quantities (e.g., COM, Mol, and mass) of the automatically generated part are equivalent to specified targets. These targets are the inertial values used in the initial assembly level simulation. The reaction and external forces acting on the component of interest resulting from assembly-level simulation provide the boundary conditions used for part-level generation. By constraining the inertial properties according to the presently described embodiments, there is no need to evaluate the assembly-level dynamics each time a part is generated.

In this regard, by considering some subset of the elements of, for example, the Mol tensor, location of the CoM, and volume fraction (or equivalently mass) as targets, I^{ij}_{target}, r_{target}, and V_{target}, respectively, the optimization formulation of Equations (1a, 1b, 1c) can be modified resulting in the following formulation that ensures inertial targets are met. It should be appreciated that mass and volume fraction correspond to the same or an equivalent metric for components formed of a single material. At the very least, for all types components, both mass and volume fraction relate to a metric representing an amount of material. Therefore, according to the presently described embodiments, mass and volume fraction are viewed as suitable equivalent, alternative or comparable inertial constraints to one another, to be considered in analysis along with other noted inertial constraints such as center of mass and moment of inertia (or inertial tensor).

$$\begin{matrix}Minimize & φ ( Ω ) , \\ Ω ⊆ {Ω}_{0} & \end{matrix} \qquad ( 2 a ) ( objective function )$$

$$\begin{matrix}such that & [ {K}_{Ω} ] [ {u}_{Ω} ] = [ f ] ,\end{matrix} \qquad ( 2 b ) ( state equation )$$

$${( {V}_{Ω} - {V}_{target} )}^{2} \leq {ϵ}_{V}^{2} , \qquad ( 2 c ) ( constraint )$$

$${( {I}_{Ω}^{ij} - {I}_{target}^{ij} )}^{2} \leq {ϵ}_{I}^{ij} , \qquad ( 2 d ) ( constraint )$$

$${( {r}_{Ω} - {r}_{target} )}^{T} ( {r}_{Ω} - {r}_{target} ) \leq {ϵ}_{r}^{2} , \qquad ( 2 e ) ( constraint )$$

where ∈_{V}, ∈^{ij}_{I} and ∈ᵣ are the small allowable thresholds for violating the volume fraction, Mol, and CoM constraints and I_{Ω} and r_{Ω} are the moments of inertia and center of mass calculated over the domain. These constraints are easily differentiable with respect to a density field and thus can easily be used in the topology optimization loop.

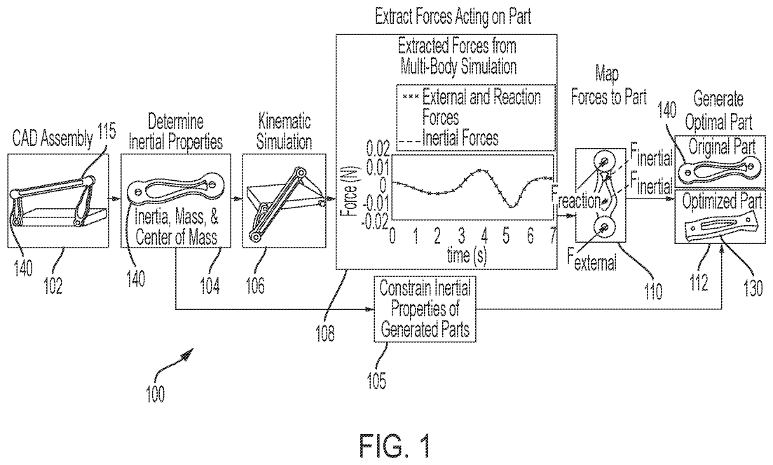

Thus, according to the presently described embodiments, a framework, method, and system enable automatic generation of structures such that the resulting inertial properties are guaranteed (or within an acceptable range) to meet a target. With reference to FIG. 1, a workflow 100 is illustrated. As shown, a component part 140 of an assembly 115 is selected to be manufactured. It should be appreciated that the assembly can be represented or modeled in a variety of different environments but, in one example, the assembly 115 is represented in a computer-aided design (CAD) format (e.g., at 102). Referring back to the workflow 100, it can be seen that, once the component part 140 is selected, the inertial properties thereof are determined (e.g., at 104). These marked properties may vary but, in at least one form of the presently described embodiments, the inertial properties include inertia, mass and center of mass. These inertial properties are used as constraints (at 105) in the process of generating the alternative or improved, e.g., optimized, part 130 (at 112) that is based on the selected part 140 to be replaced. After the inertial properties are determined (at 104), a kinematic simulation (e.g. a multi-body simulation) is performed (at 106). Based on the simulation, forces acting on the part are extracted (at 108). As shown in this example, the extracted forces (force (N)) from the multi-body simulation over time (time (S)) show that the inertial forces are coincident with the external and reaction forces. These forces are then mapped to the part (at 110). With this information, as well as the previously noted inertial constraints, an improved, e.g., an optimal, part is generated (at 112). It should be appreciated that the workflow 100 may take a variety of forms in a variety of different environments to act on a variety of different assembly designs, such as assembly 115. However, as shown, although it may take any suitable form, the kinematic simulation 106 is used to determine forces that along with a plurality of target inertial constraints, are used to generate better parts. As will be apparent to those of skill in the art, several suitable techniques could be implemented make these determinations. The inertia constrained automated part generation system may also take any suitable form but, in at least one form, will reflect the optimization formulation of Equations (2a-2e) to achieve an optimized, or improved design for a part 130.

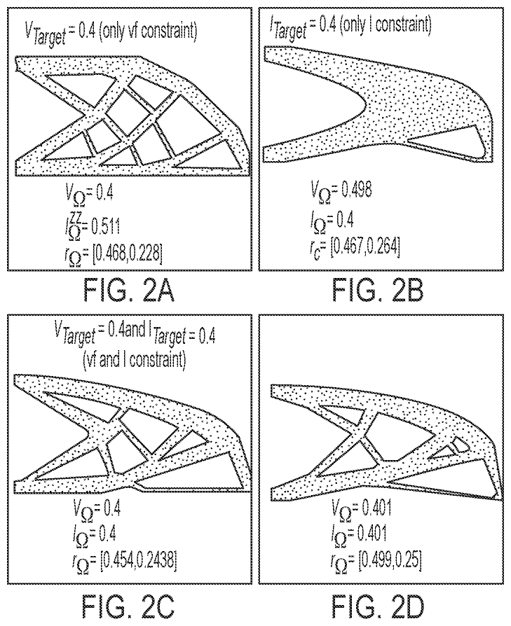

The impact of the approach implemented according to the presently described embodiments is illustrated in FIGS. 2(a)-(d). FIGS. 2(a)-(d) provide an illustration for how these constraints can influence a design and be satisfied simultaneously. It should be appreciated, a single unitary part is depicted in each of FIGS. 2(a)-(d). However, according to the presently described embodiments, it is understood that such a single unitary part may be designed and realized or manufactured according to the presently described embodiments, or multiple parts of a sub-assembly (e.g., a multi-part subassembly) that is being replaced in a large assembly may be so designed and realized or manufactured. Further, if multiple parts or a multi-part sub-assembly are being replaced in an assembly, the multiple parts or multi-part sub-assembly may be produced as a single unitary component according to the presently described embodiments. Thus, a multi-part component or sub-assembly can be replaced, according to the presently described embodiments, by a single unitary part. In addressing replacement of multiple parts, much like replacement of a single part, the considerations of the design are to improve performance, reduce cost and minimize effect of the modification.

FIG. 2(a) shows an example design using volume fraction (or mass) as an inertial constraint. FIG. 2(b) shows an example design using moment of inertia (Mol) as an inertial constraint. FIG. 2(c) shows an example design using volume fraction (or mass) and moment of inertia (Mol) as inertial constraints. FIG. 2(d) shows an example design using volume fraction (or mass), moment of inertia (Mol) and center of mass (COM) as inertial constraints. As can be seen, different combinations of inertial constraints used in an automated design process have different impacts on the functional characteristics and physical appearance of the part. In at least one form of the presently described embodiments, a plurality of inertial constraints, such as those shown in FIG. 2(b) and FIG. 2(d), are used in the automated part design generation system, such as, for example, the inertia constrained automated part generation system 125.

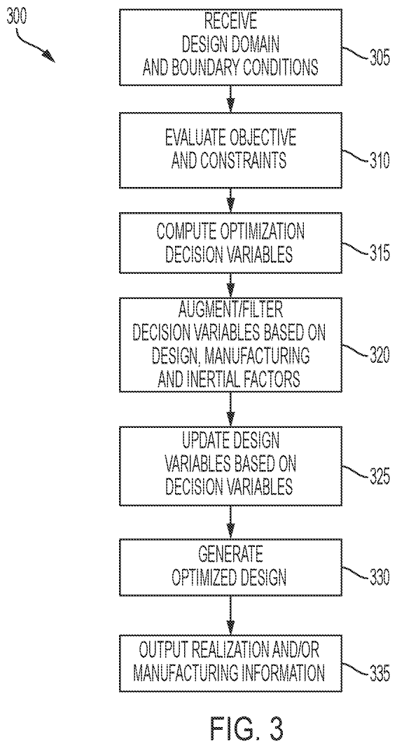

To further explain the techniques according to the presently described embodiments, reference is now made to FIG. 3. In FIG. 3, a method 300 is illustrated. The method 300, accordingly to the presently described embodiments, provides an automated design process that is initiated by establishing the domain specification. In at least one form, this includes receiving the design domain and boundary conditions for the part to be generated (at 305). This information can be input to the system in a variety of manners including those explained in connection with FIG. 1. Next, a suitable physics-based performance analysis is performed by invoking physics solvers, such as finite element analysis, to evaluate an objective and any constraints (at 310). This analysis may be implemented in a variety of manners, as will be appreciated by those of skill in the art. Decision variables (e.g., optimization decision variables) are then computed (at 315). These decision variables include, for example, gradients, sensitivity fields, etc. based on the objective and the constraints. Of course, any suitable decision variable may be used. The decision variables are then augmented and/or filtered (at 320) based on design, manufacturing, and inertial considerations. As noted above, the plurality of inertial considerations comprises, for example, mass, moment of inertia, and center of mass. Other inertial considerations may also be used. Design generation is then accomplished by updating design variables (at 325) based on decision variables and generating an improved or optimized design (at 330). The design generation may be realized in any of a variety of manners; however, according to the presently described embodiments, the design generation will include a plurality of inertial constraints, as described herein. Last, in at least one form, suitable information for a realization and/or manufacturing process is output to an appropriate realization or manufacturing system (at 335). This could occur in any of a variety of manners and, in at least one embodiment, could take the form of a three-dimensional printing, additive, subtractive or hybrid manufacturing, or a simulation—as mere examples.

Since the inertial properties of the part, e.g. optimized part 130, do not change upon generation, we can conclude that the assembly-level model, e.g. assembly model 115, will remain unchanged as well. This implies the reaction and external forces/torques acting on the components will also be unchanged.

Thus, the method and system according to the presently disclosed embodiments can automatically improve or optimize a shape to meet multiple physical performance criteria while ensuring that resulting shape is, in at least one form, guaranteed (or within an acceptable range) to simultaneously (or substantially simultaneously or concurrently) satisfy the inertial constraints. This approach decouples assembly-level design from the part-level by ensuring essential inertial properties are sufficiently, e.g., always, constant. This reduces or eliminates the need for iteratively evaluating models at both levels.

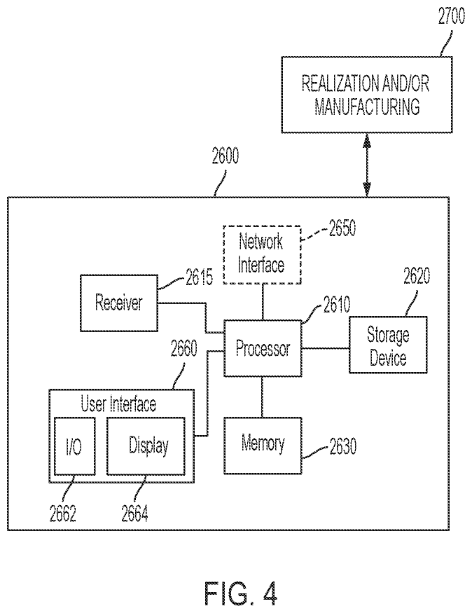

With reference now to FIG. 4, the above-described methods can be implemented on a computer using well-known computer processors, memory units, storage devices, computer software, and other components. A high-level block diagram of such a computer is illustrated in FIG. 4. Computer 2600 contains at least one processor 2610, which controls the overall operation of the computer 2600 by executing computer program instructions which define such operation. The computer program instructions may be stored in at least one storage device or memory 2620 (e.g., a magnetic disk or any other suitable non-transitory computer readable medium or memory device) and loaded into another memory 2630 (e.g., a magnetic disk or any other suitable non-transitory computer readable medium or memory device), or another segment of memory 2620, when execution of the computer program instructions is desired. Thus, the steps of the methods described herein (such as method 300 of FIG. 3) may be defined by the computer program instructions stored in the memory 2630 and controlled by the processor 2610 executing the computer program instructions. The computer 2600 may include one or more network interfaces 2650 for communicating with other devices via a network. The computer 2600 also includes a user interface 2660 that enables user interaction with the computer 2600. The user interface 2660 may include I/O devices 2662 (e.g., keyboard, mouse, speakers, buttons, etc.) to allow the user to interact with the computer. Such input/output devices 2662 may be used in conjunction with a set of computer programs as an annotation tool to annotate images in accordance with embodiments described herein. The user interface also includes a display 2664 for displaying images and spatial realism maps to the user.

According to various embodiments, FIG. 4 is a high-level representation of possible components of a computer for illustrative purposes and the computer may contain other components. Also, the computer 2600 is illustrated as a single device or system. However, the computer 2600 may be implemented as more than one device or system and, in some forms, may be a distributed system with components or functions suitably distributed in, for example, a network or in various locations.

It will be appreciated that at least one form of the presently described embodiments will include a realization and/or manufacturing system 2700. The realization or manufacturing system 2700 may take any form suitable for a particular application. For example, the system 2700 may take the form of a three-dimensional printer or another system capable of additive, subtractive, or hybrid manufacturing. In some forms, the system 2700 may comprise a system for generating a simulation of an end product. Again, various output techniques may be realized for the realization and/or manufacturing system 2700.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to facilitate embodiments described above.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for automated design generation, the method comprising:
receiving design domain and boundary conditions for at least one part of an assembly to be generated;
evaluating an objective and constraints;
computing decision variables based on the objective and the constraints;
augmenting or filtering the decision variables based on at least a plurality of inertial considerations;
determining or updating design variables based on decision variables;
generating a design for the at least one part; and
outputting information configured to realize or manufacture the at least one part.

2. The method as set forth in claim 1, wherein the evaluating comprises performing a finite element analysis.

3. The method as set forth in claim 1, wherein the decision variables comprise gradients and sensitivity fields.

4. The method as set forth in claim 1, wherein the plurality of inertial considerations comprises mass, moment of inertia, and center of mass.

5. The method as set forth in claim 1, wherein the augmenting or filtering is also based on design or manufacturing considerations.

6. The method as set forth in claim 1, wherein the outputting information configured to realize or manufacture comprises outputting information configured for at least one of: three-dimensional printing, additive manufacturing, subtractive manufacturing, or hybrid manufacturing.

7. The method as set forth in claim 1, further comprising outputting information for further simulation or analysis before realization or manufacturing.

8. A system for automated design generation, the system comprising:
at least one processor and at least one memory having instructions stored thereon wherein execution of the instructions by the processor causes the system to:
receive design domain and boundary conditions for at least one part of an assembly to be generated;
evaluate an objective and constraints;
compute decision variables based on the objective and the constraints;
augment or filter the decision variables based on at least a plurality of inertial considerations;
determine or update design variables based on decision variables;
generate a design for the at least one part; and
output information configured to realize or manufacture the at least one part.

9. The system as set forth in claim 8, wherein the evaluating comprises performing a finite element analysis.

10. The system as set forth in claim 8, wherein the decision variables comprise gradients and sensitivity fields.

11. The system as set forth in claim 8, wherein the plurality of inertial considerations comprises mass, moment of inertia, and center of mass.

12. The system as set forth in claim 8, wherein the augmenting or filtering is also based on design or manufacturing considerations.

13. The system as set forth in claim 8, wherein the information output to realize or manufacture comprises at least one of information configured for: three-dimensional printing, additive manufacturing, subtractive manufacturing, or hybrid manufacturing.

14. The system as set forth in claim 8, further comprising a realization or manufacturing system.

15. The system as set forth in claim 14, wherein the realization or manufacturing system comprises at least one of: a three-dimensional printing system, an additive manufacturing system, a subtractive manufacturing system, or a hybrid manufacturing system.

16. The system as set forth in claim 8, wherein the system is further caused to perform further analysis or simulation before information is output to realize or manufacture the part.
